(19) United States
(12) Patent Application Publication
(10) Pub. No.: US 2008/0303879 A1
(43) Pub. Date: Dec. 11, 2008

(54) INK CARTRIDGE FOR INKJET PRINTERS

(76) Inventor: Shui Kuen NIP, North Point (HK)

Correspondence Address: RABIN & Berdo, PC, 1101 14TH STREET, NW, SUITE 500, WASHINGTON, DC, 20005, US

(21) Appl. No.: 12/133,518

(22) Filed: Jun. 5, 2008

(30) Foreign Application Priority Data
Jun. 8, 2007 (CN) 200720052561.1

(51) Int. Cl. B41J 2/175

(52) U.S. Cl. 347/86

(57) ABSTRACT

An ink cartridge for an inkjet printer having a printhead with an ink outlet needle (19) comprises an ink cartridge body and a sealing plug (25). The ink cartridge body comprises an ink cartridge housing (3) and an ink cartridge cover (4) thereby forming an ink storage chamber (18). The sealing plug (25) is located in an ink outlet (14) of the ink cartridge body and has a sealing ring (26) formed on an outer substantially cylindrical surface thereof. The seal plug (25) comprises an elastic sealing member (21) having a slit (28) through which the ink outlet needle (19) of the printhead can be inserted and an inner chamber (27) respectively formed in two end faces thereof, and an inner plug (24) that is contained in the inner chamber (27).

### FIELD OF THE INVENTION

The present invention relates to an ink cartridge for use in inkjet printers, and more particularly to an ink cartridge having an improved seal of the ink outlet.

### BACKGROUND OF THE INVENTION

Chinese Patent Application 200620003627.3 describes an ink cartridge where an ink cartridge body is filled with ink but does not contain internal ink-absorbent materials (e.g. ink-storing foam). This means that the problem of having too much residual ink left in the ink-absorbent materials is avoided. Ink cartridges that lack ink-absorbent materials are also easier to recycle, cheaper to manufacture, and less polluting to the environment when discarded. The ink cartridge has an ink supply adjusting valve with a special structure, so that it can further solve the problems of the prior art in ink cartridges where the ink supply pressure adjusting structures being too complicated causing high manufacture costs and unguaranteed product quality. Also, inside the ink cartridge, since there is an air inlet adjusting valve which consists of a valve core, a valve base and a valve cover and can be assembled independently as a common part for many different models of ink cartridges, the cap-shaped valve core, which is used for covering a vent opening in the valve, has a fixed position and uniform elasticity, so that the normal closed valve is in a stable and reliable state of working pressure. Due to the new valve structures, the problems of unstable static closing pressure found in prior single-component type one-way air inlet valves where wide fluctuation in the range of negative pressure within the ink storage chamber caused by too high precision assembly requirements of the valves, is therefore avoided. However, a sealing member is axially fixed in an ink outlet of the ink cartridge and the sealing of the ink outlet before assembly is achieved by welding a plastic thin film on an outer end face of the ink outlet. During the installation of the ink cartridge to an ink outlet needle of a printhead must therefore pierce through the thin film and this provides an unwanted resistance. Moreover, the irregular broken edges of the thin film can sometimes enter into the seal hole of the sealing member along with the ink outlet needle rendering the sealing unreliable.

### SUMMARY OF THE INVENTION

An object of the present invention is to improve the structure of the seal for an ink outlet of an ink cartridge in order to ensure the reliability of sealing the ink outlet of the ink cartridge before and after the ink cartridge is installed to the printhead of an inkjet printer and to reduce the resistant force when the ink cartridge is installed to the printhead of an inkjet printer.

To achieve the above-mentioned object, an ink cartridge for an inkjet printer in accordance with the present invention is disclosed. The inkjet printer will normally include a printhead having an ink outlet needle to which the ink cartridge is assembled. The ink cartridge comprises an ink cartridge body, including an ink storage chamber. A sealing plug is located in an ink outlet of the ink storage chamber (that is, the ink outlet of the ink cartridge) and has a sealing ring formed on an outer substantially cylindrical surface thereof. The sealing plug includes an elastic sealing member having a slit through which the ink outlet needle of the printhead can be inserted and an inner chamber respectively formed in two end faces thereof, and an inner plug that is contained in the inner chamber.

The sealing ring of the seal member is preferably annular and provides a fluid-tight seal between the outer substantially cylindrical surface of the seal member and the ink outlet in which the sealing plug is located.

The inner chamber of the sealing member preferably has a small opening (i.e. one that is at least slightly smaller than the relevant outer dimension of the inner plug) with an inner side surface and an outer side surface that are both conical hole surfaces with large cone angles. The opening may expand by elastic deformation to allow the passage of the inner plug in both directions before shrinking back to its original structure, and is preferably bounded by a resilient skirt portion of the sealing member. Such an arrangement makes it easier to push the inner plug through the opening into the inner chamber to assemble the sealing plug, and also to push the inner plug out of the inner chamber through the opening when the ink cartridge is assembled to the printhead and the ink outlet needle comes into contact with the inner plug. It also allows the inner plug to be securely seated and come in contact with the outer side surface to close or seal the opening when the ink cartridge is no longer installed to the printhead.

The slit can be formed by a thin-edge cutting blade. The slit preferably cuts axially through the end face of the sealing member and is connected with the inner chamber and provides a fluid-tight seal with the ink outlet needle when the ink cartridge is installed to the printhead. The size of the slit is appropriately chosen such that it closes by itself into a self-sealing state when not being opened under the action of any external force. The slit therefore provides a fluid-tight seal to prevent the leakage of ink from the ink storage chamber at all times when the ink cartridge is not installed to the printhead (i.e. when the ink outlet needle of the printhead is not inserted through the slit).

The inner plug is preferably substantially rigid and may be made of the same plastic material as the ink cartridge, for example. The inner plug is preferably shaped like a solid or hollow ball to avoid the need of any specific assembly orientation. However, the inner plug may take any convenient shape such as a circular cone or a cylinder, etc.

After the sealing plug is assembled into the ink outlet of the ink cartridge, a retaining flange is preferably formed at the ink outlet by heat staking of the end surface material of the ink outlet to axially fix the sealing plug in the ink outlet.

The ink cartridge preferably further includes an ink supply adjusting valve connected with the ink outlet of the ink storage chamber and having a valve body defining a plurality of ink chambers connected with each other a plurality of ink channels. At least one of the ink chambers of the ink supply adjusting valve preferably includes a filter mesh. The ink supply adjusting valve preferably further includes an ink inlet that extends into a recessed portion of a bottom surface of the ink storage chamber.

The ink cartridge preferably further includes an air inlet adjusting valve connected with an air inlet of the ink storage chamber. The air inlet adjusting valve preferably includes a cap-shaped elastic valve core, a three-way valve base and a through-hole type valve cover.

The improved seal structure for the ink outlet of the ink cartridge can provide all kinds of sealing forms for the ink outlet of the ink cartridge before and after the installation of the ink cartridge to the printhead of an inkjet printer. Furthermore, since there is no plastic thin film welded on the outer end face of the ink outlet of the ink cartridge, the resistant force against the installation of the ink cartridge to the printhead is reduced and the sealing between the ink outlet of the ink cartridge and the ink outlet needle of the printhead becomes more reliable.

### BRIEF DESCRIPTION OF THE DRAWINGS

Detailed structures of the present invention are shown in the following embodiments and drawings:

FIG. 1 is a longitudinal cross-sectional view showing an ink cartridge installed onto the ink outlet needle of a printhead;

FIG. 2 is a partially enlarged view showing the ink outlet of the ink cartridge depicted in FIG. 1 detached from the ink outlet needle of the printhead;

FIG. 3 is an enlarged bottom view of sealing plug of the ink outlet; and

FIG. 4 is a cross-sectional view taken on line C-C in FIG. 3.

In these figures, the labels and their corresponding part names are:
“1”—air inlet adjusting valve
“2”—ink supply adjusting valve
“3”—ink cartridge housing
“4”—ink cartridge cover
“5”—ink chambers
“6”—ink channels
“7”—filter mesh
“8”—valve core
“9”—valve base
“10”—valve cover
“11”—valve body
“12”—front film
“13”—rear film
“14”—ink outlet of ink cartridge
“15”—ink inlet of ink supply adjusting valve
“16”—ink outlet of ink supply adjusting valve
“17”—air inlet
“18”—ink storage chamber
“19”—ink outlet needle
“20”—retaining flange
“21”—sealing member
“22”—ink
“23”—sealing plug for ink filling hole
“24”—inner plug
“25”—sealing plug for ink outlet of ink cartridge
“26”—sealing ring
“27”—inner chamber
“28”—slit
“29”—skirt portion
“30”—second end face

### DETAILED DESCRIPTION OF THE PREFERRED EMBODIMENTS

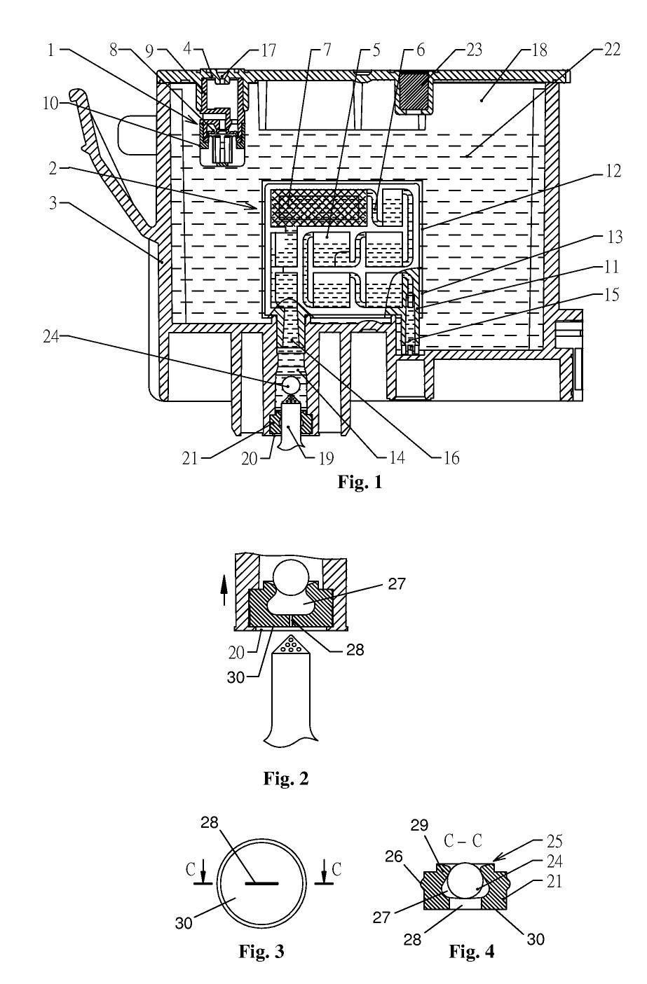

As shown in FIG. 1 to FIG. 4, an ink cartridge (sometimes called an ink box) includes five main components: an ink cartridge housing 3, an ink cartridge cover 4, an ink supply adjusting valve 2, an air inlet adjusting valve 1, and a sealing plug 25 for ink outlet of the ink cartridge.

The ink supply adjusting valve 2 which comprises a valve body 11, a filter mesh 7, a front film 12 and a rear film 13, may be assembled independently and is inserted into an upper end opening of an ink outlet 14 of the ink cartridge body 3 by an interference fit. The front and rear films 12 and 13 which are welded respectively to the front and rear surfaces of the valve body together with at least two through holes on the valve body 11 form the small ink chambers 5. The ink chambers 5 are connected by ink channels 6 which are long small grooves on the front and rear faces of the valve body 11 and act as damping orifice within the valve body 11. The ink chambers 5 are connected with each other via double ink channels 6 to ensure that the ink in the ink supply adjusting valve 2 flows smoothly and continuously. At least one of the ink chambers 5 has a filter screen 7 installed in it.

An elongated ink inlet 15 and an ink outlet 16 having a relatively large diameter are formed at a lower region of the ink supply adjusting valve 2. The upstream opening of the ink inlet 15 extends into a recessed portion in the bottom surface of an ink storage chamber 18 of the ink cartridge housing 3 so that all of the ink 22 that is stored in the ink storage container can be drawn through the ink inlet. The ink outlet 16 of the ink supply adjusting valve 2 and the ink outlet 14 of the ink cartridge housing 3 are connected with each other. The above structure ensures that both the flow rate and the pressure of the ink 22 in the ink supply adjusting valve 2 can be controlled properly and effectively.

The air inlet adjusting valve 1 which comprises a valve core 8, a valve base 9 and a valve cover 10, may be assembled independently and is connected with an air inlet 17 of the ink cartridge cover 4. The column-shaped valve base 9 has a three-way structure. The valve core 8 is fixed in a large hole in the lower end of the valve base 9 by the through-hole type valve cover 10. The valve core 8 is shaped like a cap with a boss on a top surface thereof which is made of a resilient material such as silicon rubber and is pressed to seal an end face of a vent opening connecting the large hole in the lower end of the valve base 9 with a transverse small hole. The air inlet adjusting valve 1 is normally closed but can be selectively opened during working of the printhead as described in more detail below.

The sealing plug 25 which comprises a sealing member 21 and an inner plug 24, may be assembled independently and is mounted in a lower end opening of the ink outlet 14 of the ink cartridge housing 3. The sealing member 21 is shaped like a substantially circular disc and is made of a resilient material such as silicon rubber. As shown in FIG. 4 the sealing member 21 has an annular sealing ring 26 with a thin and small semicircular cross-section formed on its outer cylindrical surface. An inner chamber 27 and a slit 28 are respectively formed in the centers of the two end faces of the sealing member 21. More particularly, the inner chamber 27 is formed in a first end face of the sealing member 21 and is defined by an annular skirt portion 29 of the sealing member. The slit 28 is formed in a second end face 30 of the sealing member and extends between the outer surface of the second end face and the inner chamber 27 as shown in FIG. 2 and FIG. 4. The inner chamber 27 has a small opening in the first end face of the sealing member 21 and defines a chamber for containing an inner plug 24. The opening in the first end face of the sealing member 21 has an inner side surface and an outer side surface which are both conical surfaces with large cone angles. The slit 28 is punched through the second end face 30 by a thin-edged cutting blade. The slit 28 locating in the second end face 30, as shown in FIG. 3, is a long opening a very small gap which is close to zero. The slit 28 closes off by itself to be in a “self-sealing” state before being opened under the action of any external force. The inner plug 24 is a simple rigid solid ball made of the same plastic material as the ink cartridge housing 3. The sealing member 21 and the inner plug 24 are assembled together to form the sealing plug 25 before being mounted into the ink outlet 14 of the ink cartridge housing 3. During assembly, because the inner plug 24 is ball-shaped there is no specific need of assembly orientation and the inner plug 24 may be assembled by simply pushing into the inner chamber 27 through the opening in the first end face of the sealing member 21 which deforms elastically to accommodate and retains the inner plug 24 in the inner chamber 27 by means of the elastic contraction of the chamber opening. As shown in FIG. 4, the inner conical surface of the opening and a bottom surface of the inner chamber 27 are in sealing contact with the inner plug 24 simultaneously to form a reliable inner circular seal for the seal plug 25. After the seal plug 25 is mounted into the ink outlet 14 of the ink cartridge housing 3, the sealing ring 26 provided on the outer cylindrical surface of the sealing member 21 is closely compressed on an inner wall of the ink outlet 14 thereby forming a reliable outer circular seal for the sealing plug 25. When the ink cartridge is not installed onto an ink outlet needle 19 of a printhead of the inkjet printer, the inner and the outer circular seals described above meet the demand of providing a complete and reliable fluid-tight seal for the ink outlet 14 of the ink cartridge.

By making use of the thermoplastic property of the plastic material of the ink cartridge housing 3, an entrance flange 20 can be formed on the ink outlet 14 of the outer end face of the ink outlet 14 as shown in FIGS. 1 and 2, by heat staking process or the like, thereby a reliable axial retention of the sealing plug 25 can be achieved in the ink outlet 14 of the ink cartridge.

Before the ink cartridge is installed onto the printhead of the inkjet printer, the plastic film (not shown) which is welded on the end face of the outer opening of the air inlet 17 is to be removed in order to open the air inlet. During the ink cartridge installation, the ink outlet needle 19 of the printhead is inserted into the slit 28 formed in the second (lower) end face of the sealing member 21 and comes into contact with the lower surface of the inner plug 24. Further insertion of the ink outlet needle 19 gradually makes the inner plug 24 overcoming the restraining force exerted by the skirt portion 29 which is located in the upper end face of the sealing member 21 and separating from the sealing member 21, finally leaving the inner plug seating at the tip of ink outlet needle 19. Due to the fact that the inner plug 24 has a rigid ball-shaped surface which forms only a point contact with the conical surface on the top of the ink outlet needle 19, so that the inner plug 24 only partially covers at most one of a plurality of ink outlet small holes arranged in the conical surface. In other words, the inner plug 24 cannot cover all of the ink outlet small holes and so cannot block up the ink outlet needle 19. After installation, the opening of the inner chamber 27 of the sealing member 21, which was elastically expanded to accommodate the separation of the inner plug 24, elastically contracts onto the outer cylindrical surface of the ink outlet needle 19 to form a reliable fluid-tight seal between the ink outlet 14 of the ink cartridge and the ink outlet needle 19 of the printhead. A further fluid-tight seal is also provided between the slit 28 and the outer cylindrical surface of the ink outlet needle 19.

FIG. 1 illustrates the condition when the ink cartridge is installed onto the ink outlet needle 19 of the printhead of an inkjet printer. When the printhead is in a non-working condition, the air inlet adjusting valve 1 of the ink cartridge is in a normally closed condition, all forces acting from inside and outside of the ink cartridge upon the air inlet adjusting valve 1 are in a state of static equilibrium, the pressure in the ink storage chamber 18 is slightly lower than the external atmospheric pressure so that the ink storage chamber is in a state of suitable and slightly negative pressure so that the ink 22 is in a state of static equilibrium and therefore cannot leak out from the ink outlet needle 19.

When the printhead is working, the ink outlet 14 of the ink cartridge forms a relatively low pressure area therein under the effect of a suction force from the printhead, and the low pressure area rapidly progresses in turn into the ink supply adjusting valve 2 and the ink storage chamber 18. The two films 12, 13, which are symmetrically welded on the respective front and the rear surfaces of the valve body 11 of the ink supply adjusting valve 2, undergo inward concave movement simultaneously so that the space in the valve body becomes smaller and the pressure in the ink supply adjusting valve 2 increases. Part of the ink in the ink supply adjusting valve 2 flows towards the ink outlet 14 of the ink cartridge at this time and the rate of the ink flow suitably increases. When the low pressure area expands to the ink storage chamber 18, the static balance of the air inlet adjusting valve 1 is broken, so the higher external atmospheric pressure outside the valve overcomes the resistances, such as the elastic force produced by the bending deformation of the top surface of the valve core 8 and so on, and cause the air inlet adjusting valve to be opened. Then external air passes through an upper chamber of the valve base 9 and an upper end face of the boss of the valve core 8 into the ink storage chamber 18. At this time, the closing pressure of the air inlet adjusting valve 1 decreases to zero, the degree of the bending deformation of the top surface of the valve core 8 increases with the increase in the negative pressure inside the ink storage chamber 18, and the elastic force from the top surface of the valve core increases with the degree of the bending deformation. Since the elastic force is in the direction opposite to the deformation, the elastic force always acts to resist the deformation, that is, to resist the opening of the air inlet adjusting valve 1, so that the valve maintains a state of dynamic equilibrium and therefore the pressure in the ink storage chamber 18 is always slightly higher than before the valve is opened but always lower than the external atmospheric pressure. The air inlet adjusting valve 1 is therefore used for dynamically adjusting and controlling the pressure in the ink storage chamber 18 and making the pressure keeping at generally constant value. Accordingly, when the air inlet adjusting valve 1 is opened, the pressure of the ink 22 in the ink storage chamber 18 suitably increases in order that the ink can flow from the ink storage chamber to the ink supply adjusting valve 2, then to the ink outlet 14 of the ink cartridge, and finally into the ink outlet needle 19 of the printhead. The ink supply adjusting valve 2, which has ink channels with variable cross-sections, can suitably adjust and control the rate and the pressure of the ink flowing therein.

When the printhead stops working, the front film 12 and the rear film 13 of the ink supply adjusting valve 2 relax and restore from their inwardly concaved shapes to their original state with the disappearance of the suction force. At this time, the space inside the valve body 11 increases and the pressure in the ink supply adjusting valve 2 decreases, therefore the ink in the valve 2 stops flowing outward. Furthermore, a small amount of ink flows from outside of the valve into the valve through the ink inlet 15 and the ink outlet 16 of the valve respectively until the pressures of the ink inside and outside the valve achieves a balance. A suitable amount of ink is then stored in the ink supply adjusting valve 2. At the same moment, the air inlet adjusting valve 1 is restored to its normally closed condition and the ink cartridge is restored to a state of suitable and slightly negative pressure, whereby the ink is in a new state of static equilibrium.

As described above, the ink cartridge, relying on the special structures of the ink channels 6 which have regulating effects on the rate and the pressure of the ink flowing through; the films 12, 13 which apply fine adjustments to the ink flow by expansion and contraction deformations like that happen in the porous sponge structure; and the normally closed air inlet adjusting valve 1 which controls the fluctuation range of the negative pressure in the ink storage chamber 18, timely and suitably regulate the flow rate and the pressure of the ink flowing towards the ink outlet needle 19 of the printhead.

When the ink cartridge needs to be replaced, either when the ink is depleted or not, the ink cartridge is removed from the ink outlet needle 19 of the printhead. The sealing member 21 which is under the axial restrain of the flange 20 stays inside the ink outlet 14 of the ink cartridge and is now detached from the ink outlet needle 19. Due to the elastic recovery and the radial pressure of the inner surface of the ink outlet 14, the slit 28 in the second (lower) end face of the sealing member 21, which has been opened by the ink outlet needle 19, shrinks and closes to the gap state same as its original state prior to being opened. Since the slit 28 has a very small gap value closed to zero, actually the slit closes by itself to a “self-sealing” state. The said “self-sealing” state described above and the fluid-tight sealing caused by the surface tension of the residual ink in the slit achieve a reliably leak-proof seal, so that whichever orientation the detached ink cartridge is in, the residual ink in the ink cartridge can be effectively prevented from leaking out. Furthermore, when the ink cartridge is removed from the inkjet printer, it is usually positioned upward in a vertical orientation, as shown in FIG. 1. This means that the inner plug 24 without the support of the ink outlet needle 19 can overcome the limitation of the buoyant force from the ink and drop into the conical hole outside the inner chamber 27 of the sealing member 21 as shown in FIG. 2 because the inner plug 24 has a larger specific gravity than the ink and a further seal is formed on the contacting portions between the inner plug 24 and the sealing member 21, thereby further improving the leak-proof seal of the ink outlet 14 of the ink cartridge when the ink cartridge is removed from the inkjet printer.

Additionally, when the inkjet printer indicates that the ink cartridge is depleted, the ink cartridge can be removed from the inkjet printer and a sealing plug 23 can be removed from the ink filling hole. Replacement ink can then be refilled to the ink storage chamber 18 of the ink cartridge and the sealing plug 23 is reassembled to the ink cartridge. The ink cartridge can then be reinstalled into the inkjet printer again. Therefore, the recycling for reuse and the prolonging the useable life of the ink cartridge can then be realised.

1. An ink cartridge for an inkjet printer having a printhead with an ink outlet needle 19, the ink cartridge comprising:
an ink cartridge body; and
a sealing plug (25);
wherein the ink cartridge body further comprises an ink cartridge housing (3) and an ink cartridge cover (4) thereby forming an ink storage chamber (18);
wherein the sealing plug (25) is located in an ink outlet (14) of the ink cartridge body and having a sealing ring (26) formed on an outer substantially cylindrical surface thereof, wherein the seal plug (25) comprises an elastic sealing member (21) having a slit (28) through which the ink outlet needle (19) of the printhead can be inserted and an inner chamber (27) respectively formed in two end faces thereof, and an inner plug (24) that is contained in the inner chamber (27).

2. An ink cartridge as according to claim 1, wherein the inner plug (24) is substantially rigid and shaped like a solid/hollow ball, circular cone or cylinder.

3. An ink cartridge according to claim 1, wherein the seal plug (25) is axially fixed in the ink outlet (14) by an entrance flange (20) which is formed by heat staking, or ultrasonic staking or similar forming process on the end face of the ink outlet (14).

4. An ink cartridge according to claim 1, further comprising an ink supply adjusting valve (2) connected with the ink outlet (14) of the ink storage chamber (18) and including a valve body (11) defining a plurality of ink chambers (5) connected with each other a plurality of ink channels (6).

5. An ink cartridge according to claim 1, wherein at least one of the ink chambers (5) of the ink supply adjusting valve (2) includes a filter mesh (7).

6. An ink cartridge according to claim 1, wherein the ink supply adjusting valve (2) further comprises an ink inlet that extends into a recessed portion of a bottom surface of the ink storage chamber (18).

7. An ink cartridge according to claim 1, further comprising an air inlet adjusting valve (1) connected with an air inlet (17) of the ink storage chamber (18).

8. An ink cartridge according to claim 7, wherein the air inlet adjusting valve (1) includes a cap-shaped elastic valve core (8), a three-way valve base (9) and a through-hole type valve cover (10).
